(19) United States
(12) Patent Application Publication
(10) Pub. No.: US 2006/0292418 A1
(43) Pub. Date: Dec. 28, 2006

(54) Fuel cell system

(76) Inventors: Eiji Akiyama, Tokyo (JP); Tsutomu Yoshitake, Tokyo (JP); Takashi Manako, Tokyo (JP); Hidekazu Kimura, Tokyo (JP); Yoshimi Kubo, Tokyo (JP)

Correspondence Address: HAYES, SOLOWAY P.C., 3450 E. SUNRISE DRIVE, SUITE 140, TUCSON, AZ, 85718, US

(21) Appl. No.: 10/567,325

(22) PCT Filed: Aug. 20, 2004
(86) PCT No.: PCT/JP04/12017

§ 371 Date: Feb. 7, 2006

(30) Foreign Application Priority Data
Aug. 21, 2003 (JP) 2003-297035

(51) Int. Cl. H01M 8/04

(52) U.S. Cl. 429/34

(57) ABSTRACT

A filter 900 is disposed at an opening part of a fuel container 811. The filter 900 is constituted by disposing a carbon dioxide permselective membrane on a vapor separation membrane. The filter 900 selectively transmits carbon dioxide in a fuel 124 to emit the carbon dioxide out of a fuel cell system This structure efficiently prevents the occurrence of the phenomena that carbon dioxide adheres to the fuel electrode 102, which is a cause of a reduction in cell efficiency and the generation of carbon dioxide increases pressure, which is a cause of breakage of the fuel container 811.

### TECHNICAL FIELD

The present invention relates to a fuel cell system provided with a unit discharging carbon dioxide generated inside of the cell to the outside.

### BACKGROUND ART

Fuel cells are constituted of a fuel electrode, an oxidant electrode and an electrolyte interposed between these electrodes, wherein fuel is supplied to the fuel electrode and an oxidizer is supplied to the oxidant electrode, to generate electricity by an electrochemical reaction of the fuel. Hydrogen is generally used as the fuel. In the meantime, a direct type fuel cell that directly utilizes inexpensive and easily handlable methanol as the fuel has been enthusiastically developed in recent years.

When hydrogen is used as the fuel, the reaction at the fuel electrode is as shown in the following equation (1).
3H₂→6H⁺+6e⁻ (1)

When methanol is used as the fuel, the reaction at the fuel electrode is as shown in the following equation (2).
CH₃OH+H₂O→6H⁺+CO₂+6e⁻ (2)

Also, in all these cases, the reaction at the oxidant electrode is as shown in the following equation (3).
3/2O₂+6H⁺+6e⁻→3H₂O (3)

Particularly, because in such a direct type fuel cell, hydrogen ions can be obtained from an aqueous methanol solution, it is not required to use a reformer and the like and this direct type fuel cell has a large advantage in miniaturizing a fuel cell and putting a fuel cell into practice. Also, this fuel cell has the characteristics that the energy density of this fuel cell is very high since it uses an aqueous methanol solution as the fuel.

In such a direct type fuel cell, carbon dioxide is generated by an electrochemical reaction in the fuel electrode as shown in the above equation (2). If bubbles of this carbon dioxide are left unremoved in the vicinity of the fuel electrode, the supply of fuel is inhibited, leading to reductions in generating efficiency and the effective surface area of a catalyst, and therefore, the output of power is reduced, causing a reduction in the performance of the fuel cell. Also, if the operation of the fuel cell is continued without removing carbon dioxide, the pressure in the fuel chamber is increased, which may be a cause of leakage of a liquid fuel and a deterioration in the performance of the cell.

In Patent Reference 1, there are descriptions concerning a fuel cell provided with a separation membrane that separates carbon dioxide gas from liquid fuel and discharges carbon dioxide gas generated from a fuel electrode, selectively out of the fuel container. In the paragraph No. 0025 of the Reference, there are descriptions as to the structure of the separation membrane, which descriptions read as follows “any material may be used without any particular limitation insofar as it can separate carbon dioxide gas from liquid fuel. For example, a porous material may be used, and in the case of a methanol cell, a porous material having a pore diameter larger than the molecular diameter of carbon dioxide and smaller than the molecular diameter of methanol is preferably used. Specifically, it is preferable to use a porous material having a pore diameter of about 0.05 μm to 4.00 μm.”

There are also descriptions in Examples (Paragraph No. 0040) of the above Reference, which descriptions read as follows “A porous material constituted of a polyethylene terephthalate having a thickness of 70 μm, a pore diameter of 0.1 μm and a porosity of 68% was prepared as the separation membrane according to the present invention.”

However, in the conventional fuel cell described in the above Patent Reference 1, it is difficult to separate carbon dioxide from other gas components though the liquid fuel can be separated from carbon dioxide. In other words, byproducts, such as formic acid, methyl formate, formaldehyde and the like, generated by an electrochemical reaction of the fuel cell are included in the system of the fuel cell described in Patent Reference 1. The structure of Patent Reference 1 has the problem that even if these byproducts are generated, these byproducts are discharged out of the system together with carbon dioxide in a large amount exceeding environmental standard.

For example, Patent Reference 2 discloses measures taken to restrain formic acid and formaldehydes from being discharged in the air, wherein reaction products generated by an electrochemical reaction are separated into gas and liquid, the separated gas components are recovered by a gas component recovery unit and then, byproducts such as methanol, formaldehyde, formic acid and methyl formate are treated by an adsorbent and a catalyst which are installed in the recovery unit. This structure allows the byproducts to be adsorbed or decomposed into carbon dioxide, thereby preventing the above byproducts from being discharged in the air.
[Patent Reference 1] Japanese Laid-Open patent publication NO. 2001-102070.
[Patent Reference 2] Japanese Laid-Open patent publication NO. 2003-223920.
[Patent Reference 3] Japanese Laid-Open patent publication NO. H08-024603.

### DISCLOSURE OF THE INVENTION

When porous polyethylene terephthalate is used as described in the above Patent Reference 1, byproducts such as formic acid, methyl formate, formaldehyde and the like cannot be prevented from being discharged. In addition, a vapor of fuel methanol volatilizes through the separation membrane, causing a loss of fuel. There are also descriptions in Paragraph No. 0025 of the above Patent Reference 1, which descriptions read as follows “ . . . it is preferable to use a porous material having a pore diameter smaller than the molecular diameter of methanol and specifically a porous material having a pore diameter of about 0.05 μm to 4.00 μm.” However, the pore diameter of about 0.05 μm to 4.00 μm is larger than the molecular diameter of methanol (gas) and it is difficult to suppress the emission of methanol gas.

According to the above Patent Reference 2, byproducts can be prevented from being discharged in the air. However, when a large amount of byproducts is generated, the actions of adsorption and a catalytic reaction are insufficiently exerted. In addition, a methanol vapor is adsorbed and decomposed in the vapor recovery unit, causing a fuel loss.

The present invention has been made in light of the above situation and it is an object of the present invention to provide a fuel cell system that selectively discharges carbon dioxide out of the cell while suppressing a fuel loss and the discharge of byproducts generated therein.

According to the present invention, there is provided with a fuel cell system including a fuel cell provided with a fuel electrode, an oxidant electrode and an electrolyte membrane sandwiched therebetween, and a fuel supply system supplying fuel to the fuel electrode, the fuel cell system further including a gas discharge unit provided with a filter at a part of a member which excludes a reaction part of the fuel electrode and is in contact with the fuel, wherein the filter is constituted of a substrate and a carbon dioxide permselective membrane provided on the substrate. Here, when the fuel cell is a direct type fuel cell in which a liquid is supplied, a gas-liquid separation membrane is used as the substrate.

In other words, the present invention is characterized by the structure in which the gas-liquid separation membrane is disposed at a part that is in contact with fuel and the carbon dioxide permselective membrane is disposed on the surface of this gas-liquid separation membrane, making it possible to discharge carbon dioxide efficiently without discharging a vapor of liquid fuel, byproducts and the like after the separation of gas from a liquid. Carbon dioxide among the gas components separated by the vapor-liquid separation membrane is discharged whereas byproducts such as a methanol vapor, formic acid and the like are left on the gas-liquid separation membrane or dissolved again in the liquid, and it is therefore possible to suppress the discharge of a methanol vapor and byproducts. It is therefore possible to suppress a fuel loss and to improve energy efficiency. Also, since the discharge of byproducts can be suppressed, the present invention has high adaptability to an environment.

Because carbon dioxide is successively produced by an electrochemical reaction, the internal pressure on the vapor-liquid separation membrane side is higher than on the outside. Therefore, carbon dioxide can be discharged even if a permeable membrane is disposed on the vapor-liquid separation membrane. However, because it is desired to transmit carbon dioxide gas efficiently, the vapor-liquid separation membrane is preferably made to have a lower thickness to a certain extent. For example, if the average thickness of the vapor-liquid separation membrane is made to be 5 μm or less and preferably 1 μm or less, carbon dioxide can be efficiently discharged even if the permeable membrane is further formed on the vapor-liquid separation membrane. In the case of making such a thin membrane, it is difficult to produce the membrane by molding unlike the porous polyethylene terephthalate filter described in Patent Reference 1 and therefore, the vapor-liquid separation membrane function also as a substrate of the carbon dioxide permselective membrane.

Examples of the carbon dioxide permselective membrane that selectively transmits carbon dioxide and prevents methanol, other byproducts and the like from being discharged include non-porous fluororesin membrane constituted of at least one or more resin selected from a perfluoro polymer such as a polytetrafluoroethylene (PTFE) membrane and the like, fluoroolefin such as polyvinyl fluoride, polyvinylidene fluoride (PVDF) and polyethylenepropylene fluoride and polyfluoroalkyl carboxylate such as 1H, 1H-perfluorooctyl polymethacrylate and 1H, 1H, 2H, 2H-perfluorodecyl polyacrylate and the like and copolymers containing these polymers as polymerization units as described in Patent Reference 3, or non-porous membranes or the like of unsaturated carboxylate ester as described in Patent Reference 3. Among these compounds, the non-porous fluororesin membrane is preferably used in the point that it is superior in the balance between carbon dioxide permselectivity and membrane-forming characteristics. When liquid fuel is used, a non-porous PTFE is preferably used.

As to each of these materials, when its molecular weight is too large, it is hard to prepare a solution of the material and it is difficult to make thinner the limiting permeable layer whereas when the molecular weight is too small, there is the case where only insufficient limiting permeability is obtained. Therefore, the lower limit of the molecular weight is 1000 and preferably 3000 and the upper limit of the molecular weight is 1,000,000 and preferably 100,000. The molecular weight so-said here means a number average molecular weight, which may be measured by GPC (Gel Permeation Chromatography).

When such a material is formed on the vapor-liquid separation membrane by a spin coating method, dipping method, brush coating method or a plasma method, the membrane can be thinned to the extent that carbon dioxide can be transmitted efficiently and uniformity of membrane thickness and membrane quality are bettered.

In the meantime, no particular limitation is imposed on both the thickness and material of the substrate insofar as the carbon dioxide permselective membrane can be formed and it hinders the discharge of gas when the fuel is gas. When the fuel is a liquid, on the other hand, it is preferable to dispose the vapor-liquid separation membrane. Here, any material may be used as the vapor-liquid separation membrane insofar as it is a porous and water-repellent material. For example, a membrane made of polyether sulfone, an acrylic copolymer or the like, or PTFE, PVDF may be used. When the substrate is constituted of each of these materials, the carbon dioxide permselective membrane can be made to function based on the permeable selectivity between gas molecules. Examples of the material used as the substrate include GOATEX (registered trademark, manufactured by Japan Goatex), VERSAPORE (registered trademark, manufactured by Nippon Pall Corporation), Supor (registered trademark, manufactured by Nippon Pall Corporation) and the like. The thickness of the substrate is, for example, 50 μm to 500 μm and it is desired to make the substrate thicker than the carbon dioxide permselective membrane to thereby retain the strength to the extent that each material can function as the substrate.

The filter may be designed to have a structure in which a porous membrane is disposed on the carbon dioxide permselective membrane as well as the structure in which the carbon dioxide permselective membrane is disposed on the vapor-liquid separation membrane. Such a structure ensures that the surface of the carbon dioxide permselective membrane can be protected with the porous membrane without inhibiting discharge of carbon dioxide, whereby the durability of the filter can be improved.

The filter is disposed in any place, such as a fuel supply system constituted of a fuel container, a fuel supply tube and the like, where it is in contact with fuel and the reaction is not hindered. The filter is preferably disposed in a place where a part thereof is in contact with fuel and another part is exposed externally from the fuel cell system and more preferably disposed on the surface positioned on the top surface when used usually, whereby carbon dioxide can be discharged most efficiently.

Also, in the present invention, the gas discharge unit is designed to have a structure provided with a chamber communicated with the above fuel supply system through the above filter and may have a structure provided with a catalyst for gas transmitted through the filter in the chamber. Also, the gas discharge unit is designed to have a structure provided with a first chamber which has an air port provided with the filter and is communicated with the above fuel supply system through the filter and a second chamber which is communicated with the first chamber and provided with a catalyst oxidizing gas fed from the first chamber. According to such a structure, the fuel gas and byproducts are oxidized/decomposed by the catalyst when the fuel cell is used in the condition of temperature at which fuel gas such as methanol or the like is vaporized in an amount larger than usual and even when the filter has carbon dioxide selecting ability insufficient to separate the gas because of generation of an unusually larger amount of byproducts (for example, formic acid, methyl formate, formaldehyde and the like) in the cell. In the case of the catalyst as described in Patent Reference 2, the recovered gas component is introduced into the recovery unit as it is and exposed to the catalyst, and therefore, the efficiency of oxidation and decomposition is very low. However, according to the present invention, even in the case of using the fuel cell under the environment where byproducts are generated in an unusually large amount, firstly many byproducts are made to remain in the vapor-liquid separation membrane or to be dissolved in the liquid again by the carbon dioxide permselective membrane and then, a small amount of the byproducts transmitted through the filter is made to react catalytically, which makes it possible to oxidize/decompose the byproducts into harmless materials very efficiently to discharge these harmless materials in the air.

As the catalyst used here, metals, alloys or oxides of these containing at least one type among Pt, Ti, Cr, Fe, Co, Ni, Cu, Zn, Nb, Mo, Ru, Pd, Ag, In, Sn, Sb, W, Au, Pb and Bi, may be used. An oxidation promoting unit may be disposed to promote the oxidation of gas by a catalyst. The oxidation promoting unit may be designed to have a structure provided with a heating unit or the like that heats the gas or the catalyst. By this structure, gas transmitted through the filter can be oxidized efficiently without fail. Also, even in the case where liquefied components adheres to the catalyst after the fuel cell system is used for a long period of time, these components can be removed and therefore the fuel cell can maintain its performance. This can further improve the maintainability and reliability of the fuel cell system.

The present invention provides a fuel cell system that selectively discharges carbondioxide out of the cell while suppressing a fuel loss and the discharge of byproducts generated therein.

### BRIEF DESCRIPTION OF THE DRAWINGS

The above described object, other objects, features and advantages will be further apparent by preferred embodiments and accompanying drawings thereof.

FIG. 1 is a cross-sectional view typically showing the structure of a fuel cell system according to an embodiment.

FIG. 2 is an exploded view of a gas discharge unit of a fuel cell system.

FIG. 3 is a cross-sectional view showing a gas discharge unit of a fuel cell system according to an embodiment.

FIG. 4 is a perspective view of a fuel cell system according to an embodiment.

FIG. 5 is a cross-sectional view showing a gas discharge unit of a fuel cell system according to an embodiment.

FIG. 6 is across-sectional view typically showing the structure of a fuel cell system according to an embodiment.

FIG. 7 is a cross-sectional view typically showing the structure of a fuel cell system according to an embodiment.

FIG. 8 is a cross-sectional view typically showing the structure of a fuel cell system according to an embodiment.

FIG. 9 is a plan view typically showing the structure of a fuel cell system according to an embodiment.

FIG. 10 is a cross-sectional view along the line A-A in the fuel cell system of FIG. 9.

FIG. 11 is a plan view typically showing the structure of a fuel cell system according to an embodiment.

### BEST MODE FOR CARRYING OUT THE INVENTION

An embodiment of the present invention will be explained with reference to the drawings. The following explanations will be furnished mainly as to the case of using a liquid as the fuel. However, such an embodiment in which the fuel is gas or in the case where the fuel is a liquid and is put into a gas state when supplied to the fuel electrode is also made in the same manner. Also, as to the type of fuel, it is not limited to methanol, various types including ethanol, dimethyl ether or other alcohols or ethers or hydrocarbons or the like such as cycloparaffin or the like may be adopted. In all the following drawings, the same structural elements are represented by the same numerals and redundant explanations of these elements will not be appropriately described.

### First Embodiment

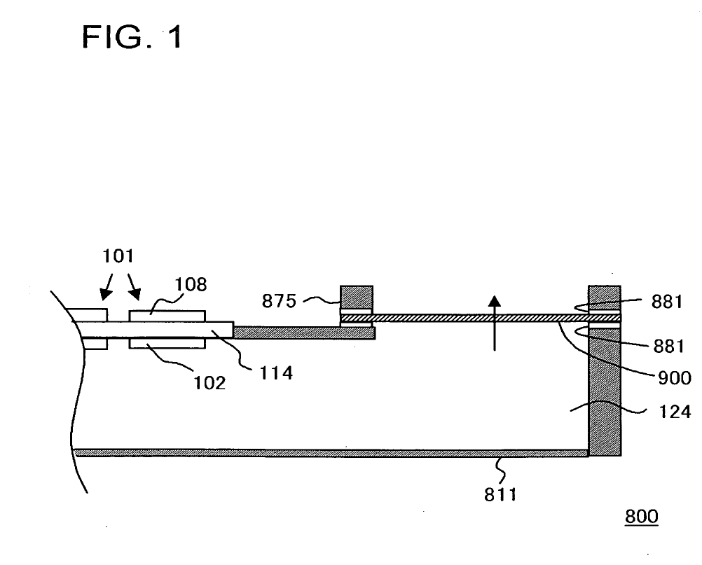

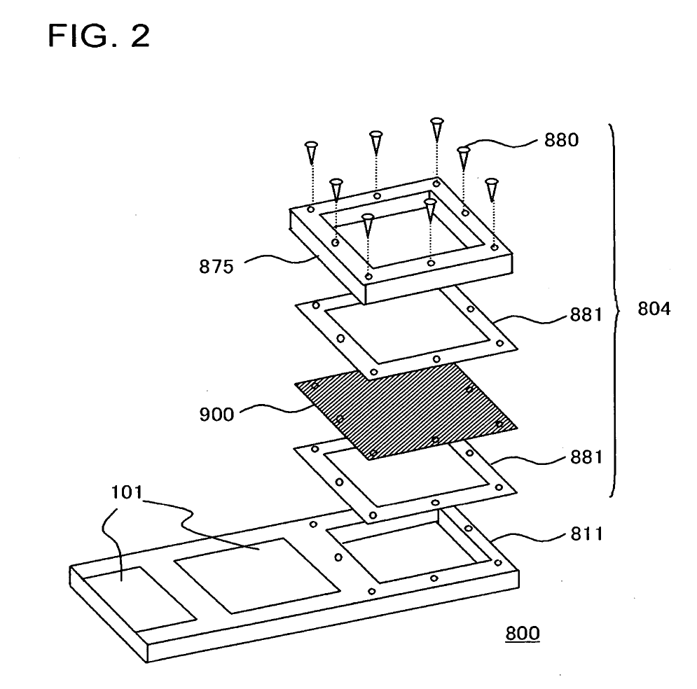

FIG. 1 is a cross-sectional view typically showing the structure of a fuel cell system in an embodiment shown in FIG. 1. Also, FIG. 2 is a perspective view of this fuel cell system.

A fuel cell system 800 is provided with plural fuel cell unit cells 101 and a gas discharge unit 804 (shown in FIG. 2) that treats gas discharged from these fuel cells unit cells 101.

The fuel cell unit cell 101 is provided with a fuel electrode 102, an oxidant electrode 108 and a solid electrolyte membrane 114 interposed between these electrodes. A fuel 124 is supplied to the fuel electrode 102 from a fuel container 811 and an oxidizer (for example, air or oxygen gas) is supplied to the oxidant electrode 108 to generate electricity by an electrochemical reaction.

In this embodiment, the gas discharge unit 804 has a structure provided with a filter 900 disposed on an opening part of the fuel container 811. The filter 900 is, as shown in FIG. 2, secured to the above opening part by a frame 875 and rivets 880. Seal materials 881 are disposed between the filter 900 and the frame 875 and between the filter 900 and the fuel container 811 respectively. The gas discharge unit 804 may be detachably attached to the fuel container 811.

The filter 900 is constituted by disposing a carbon dioxide permselective membrane on a vapor separation membrane. This carbon dioxide permselective membrane is formed by applying a polymer solution by a spin coating method. For example, a solution of a polytetrafluoroethylene, polyfluoroolefin, polyfluoroalkylacrylate or the like which is obtained by diluting with a perfluorocarbon solvent such as perfluorohexane or the like may be dipped on a porous membrane and formed as a membrane by a spin coating method to form a non-porous fluororesin membrane. At this time, the concentration of the solution is preferably about 0.1 to 10% by weight and more preferably about 1 to 5% by weight though it is changed a little depending on the material to be used. If the concentration is within this range, a better coating performance is obtained and it is therefore possible to obtain a thin membrane having excellent membrane qualities. In this case, there is no particular limitation to a method of forming this carbon dioxide permselective membrane insofar as it is a method by which a layer having a uniform thickness may be used. For example, a spray coating method, a dip-coating method or the like as well as a spin coating method may be used. When a spin coating method is used, a limiting permeable layer constituted of a thin membrane having a thickness of about 0.01 to 3 μm can be formed in a highly controlled manner.

After the above solution is applied, it is dried to form a membrane. The drying temperature is designed to be preferably in arrange from, for example, room temperature (25° C.) to 4 ° C. The drying time is usually designed to be 0.5 to 24 hours though depending on the temperature. The drying may be carried out in inert gas though the drying may be carried out in the air. For example, a nitrogen blowing method in which the coating solution is dried by blowing nitrogen against the substrate may be used.

Carbon dioxide is generated at the fuel electrode 102 by an electrochemical reaction of a fuel cell unit cell 101 to generate carbon dioxide bubbles in the fuel 124. This causes a rise in the internal pressure in the fuel container 811. The filter 900 selectively transmits carbon dioxide in the fuel 124 to discharge carbon dioxide out of the fuel cell system. This efficiently prevents the occurrence of the phenomena that carbon dioxide adheres to the fuel electrode 102, which is a cause of a reduction in cell efficiency and the generation of carbon dioxide increases pressure, which is a cause of breakage of the fuel container 811.

### Second Embodiment

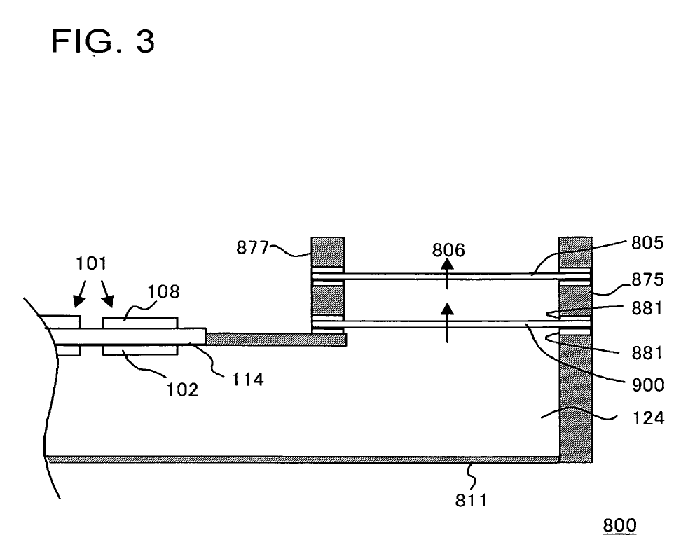

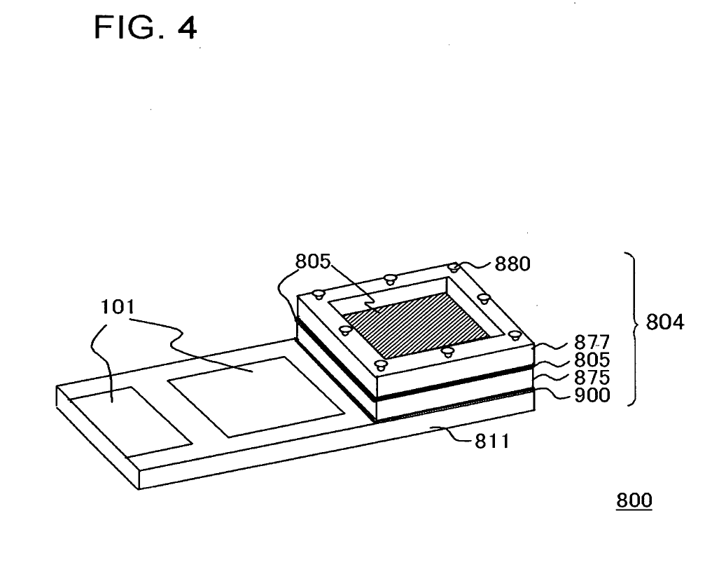

FIG. 3 is a cross-sectional view showing the structure of a gas discharge unit of a fuel cell system according to this embodiment. Also, FIG. 4 is a perspective view of this fuel cell system.

A gas discharge unit 804 has a structure in which a filter 900 and a catalyst membrane 805 are disposed at an opening part of a fuel container 811. The filter 900 is secured to the above opening part by a frame 875 and rivets 880. The catalyst membrane 805 is secured to a second frame 877 disposed in a space above the filter 900.

The filter 900 selectively transmits carbon dioxide and the like generated by an electrochemical reaction of the fuel cell unit cell 101 while restraining a vapor fuel methanol from vaporizing through the membrane.

In the meantime, the catalyst membrane 805 oxidizes trace methanol and the like and trace byproducts such as formic acid, methyl formate and formaldehyde which are transmitted through the filter 900 to convert into materials reduced in load on the environment.

In this embodiment, two types of filters differing in function, namely, the filter 900 and the catalyst membrane 805 are used and it is therefore possible to suppress a loss of methanol and the emission of trace byproducts while suppressing the emission of carbon dioxide.

### Third Embodiment

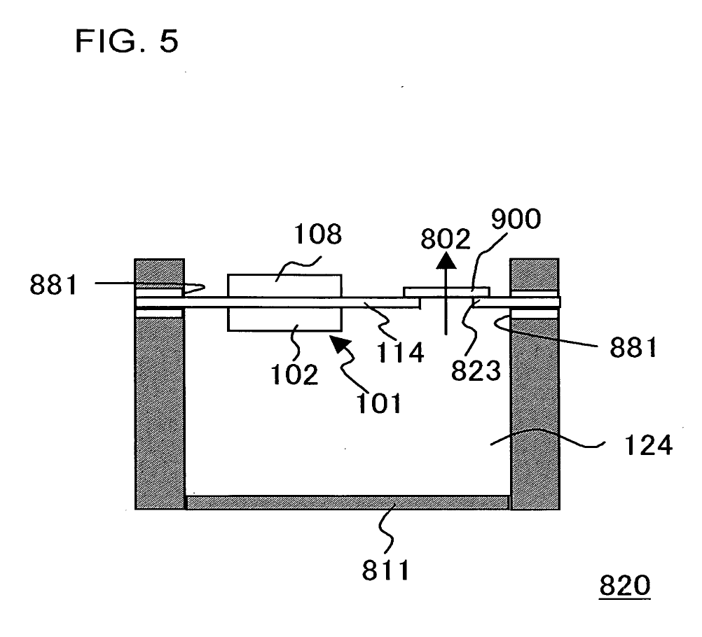

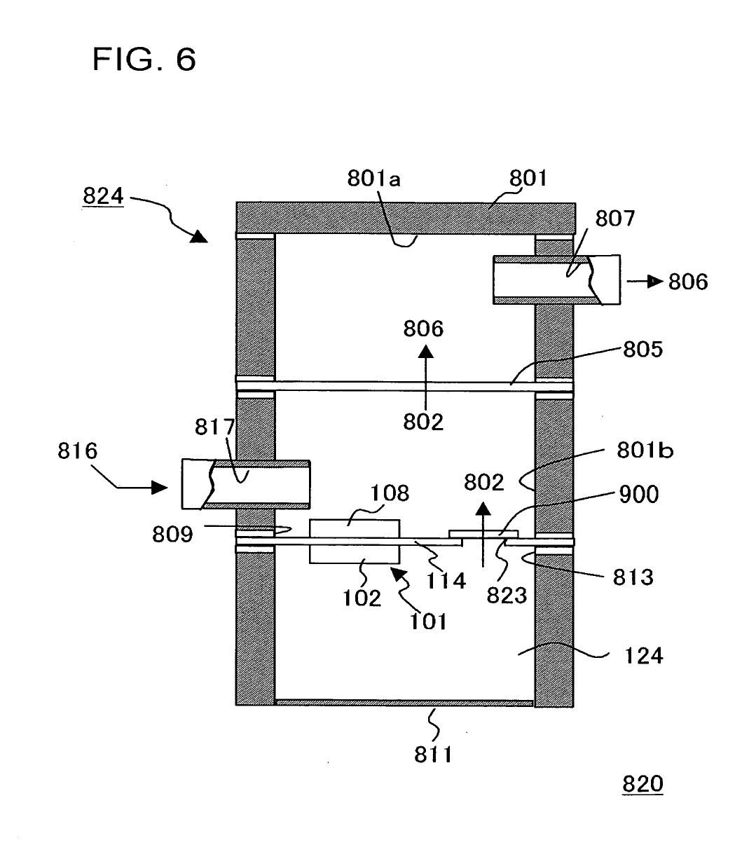

FIGS. 5 and 6 are respectively a cross-sectional view typically showing the structure of a fuel cell system 820 in this embodiment. As shown in FIG. 6, the fuel cell system 820 is provided with a upper chamber(room) 801a, a lower chamber(room) 801b, an intake 809 and an oxygen supply port 817. In this embodiment, a gas treating unit 824 is disposed in each fuel cell unit cell 101. The fuel cell unit cell 101 is disposed at an opening part 813 (shown in FIG. 6) of the fuel container 811 and a filter 900 is disposed in a hole 823 formed on a solid electrolyte membrane 114 of the fuel cell unit cell 101. This structure makes it possible to structure a compact fuel cell system and to attain miniaturization of the system because it is not necessary to dispose the region where the gas treating unit 824 is formed separately from the region where the fuel unit cell 101 is disposed.

In the structure shown in FIG. 5, gas in the fuel cell system is discharged in the air through the filter 900. The structure shown in FIG. 6 is so designed that even if trace byproducts transmitted through the filter 900 are present, these byproducts are oxidized by a catalyst membrane 805 and discharged externally.

### Fourth Embodiment

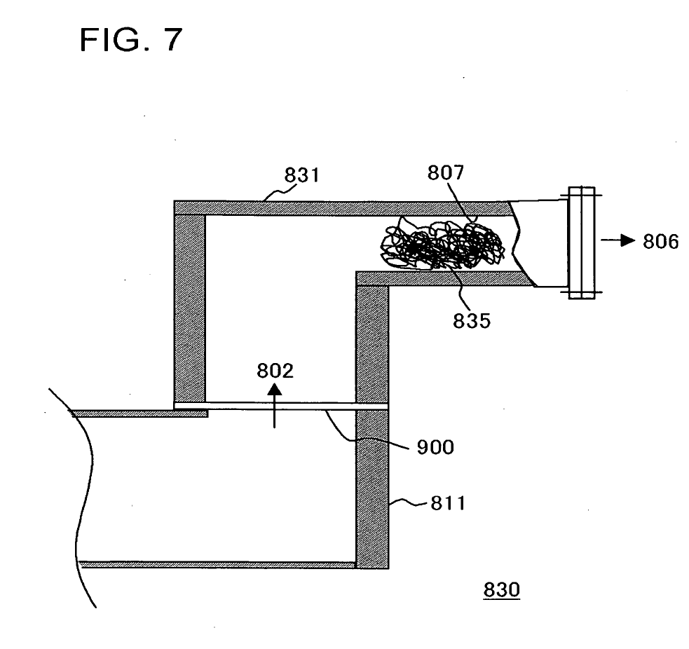

FIG. 7 is a cross-sectional view typically showing the structure of a fuel cell system in this embodiment.

The fuel cell system 830 in this embodiment has a structure in which trace byproducts and the like which are transmitted through the filter 900 are treated by a catalyst 835 having a wire-wool form. The catalyst 835 is packed in a discharge port 807 disposed on the top of a discharge passage 831.

In this embodiment, the catalyst 835 having a wire wool-form maybe the same metal, alloy or oxide as that contained in the catalyst membrane 805 explained in the second embodiment.

Though not illustrated here, an oxygen supply unit is disposed in the discharge passage 831 and oxygen may be supplied from the oxygen supply unit. Such a unit can promote oxidation by the catalyst 835.

The catalyst 835 may take various forms as long as it has a structure that can oxidize an untreated gas 802 discharged from the fuel container 811. For example, a material produced by forming a network of wires constituted of the aforementioned metal, alloy or other oxides may be used as the catalyst. This wire may be used as it is.

Even if the gas 802 containing trace byproducts is discharged from the fuel container 811 in the fuel cell system constituted in this manner, a catalytic reaction such as oxidation and adsorption by the catalyst 835 can be promoted and the performance of the catalyst 835 can be thereby maintained by heating by heating unit (not shown). It is therefore possible to improve the maintainability and reliability of the fuel cell system 830 can be improved.

In the above embodiments, the oxygen supply unit and the heating unit are mentioned as the unit promoting oxidation/adsorption/decomposition of contaminants, such as byproducts, in the discharged gas by the catalyst. However, the unit is not limited to these oxygen supply unit and heating unit. As other catalytic reaction promoting unit, for example, a pressure unit, vibration unit, stirring unit or the like may be used.

Also, the catalyst may be a photocatalyst and in this case, the catalytic reaction promoting unit may be, for example, a unit of applying light or the like. Examples of the photocatalyst include semiconductors such as titanium dioxide or the like and organic metal complexes. For example, platinum bearing microparticles of titanium dioxide may be used.

### Fifth Embodiment

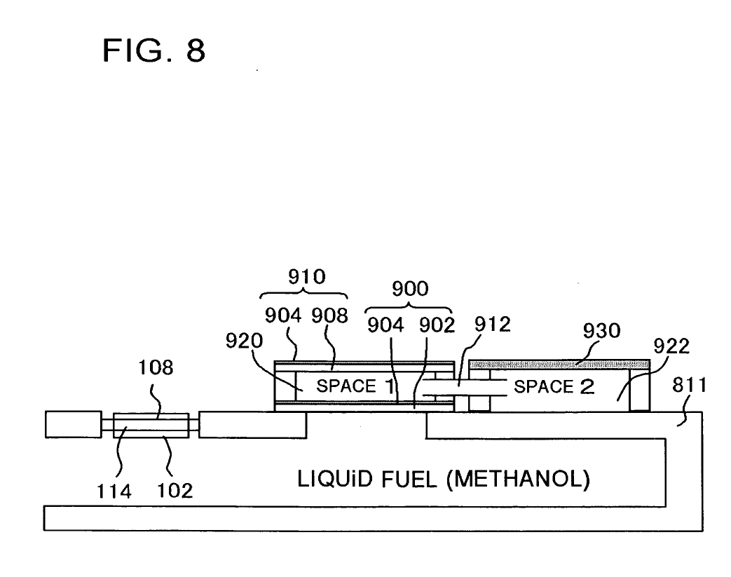

The structure of a fuel cell system according to this embodiment is shown in FIG. 8. This system includes a fuel cell provided with a fuel electrode 102, an oxidant electrode 108 and a solid electrolyte membrane 114 and a gas discharge unit.

The gas discharge unit is constituted as follows. A first chamber(room) 920 communicated with an opening part of a fuel container 811 through a filter 900 is disposed. A second chamber(room) 922 communicated with the first chamber 920 through a connecting tube 912 is disposed. A part of the outside wall of the first chamber 920 is constituted of the second filter 910.

The filter 900 has a structure in which a vapor-liquid separation membrane 902 and a carbon dioxide permselective membrane 904 are laminated on each other, the vapor-liquid separation membrane 902 being disposed on the fuel container 811 side. The material and structure of this vapor-liquid separation membrane 902 are as mentioned above and a porous membrane or the like made of a polyether sulfone, acryl copolymer, PTFE, PVDF or the like is preferably used. The second filter 910 has a structure in which a substrate 908 and a carbon dioxide permselective membrane 904 are laminated in this order, the substrate 908 being disposed on the inside of the first chamber 920. As the substrate 908, various structural materials having many hole parts may be used. For example, porous alumina, a metal fiber sheet or the like may be used.

The gas transmitted through the filter 900, specifically, the gas containing carbon dioxide, trace methanol and trace byproduct gases is introduced into the inside of the first chamber 920. Among these gases, carbon dioxide is transmitted through the upper second filter 910 and emitted out of the system, whereas trace methanol and byproduct gases are introduced into the second chamber 922 through the connecting tube 912. A part of the outside wall of the second chamber 922 is constituted of a catalyst membrane 930. The gas introduced into the second chamber 922 is oxidized by the catalyst membrane 930, converted into compounds reduced in environmental load and discharged out of the system. According to this embodiment, a loss of methanol and the amount of trace byproducts to be discharged can be efficiently suppressed while discharging carbon dioxide.

### Sixth Embodiment

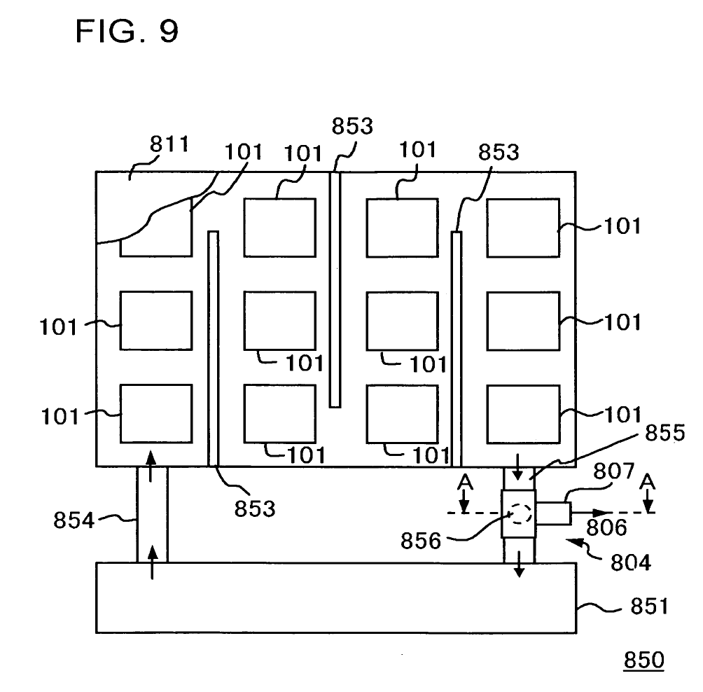

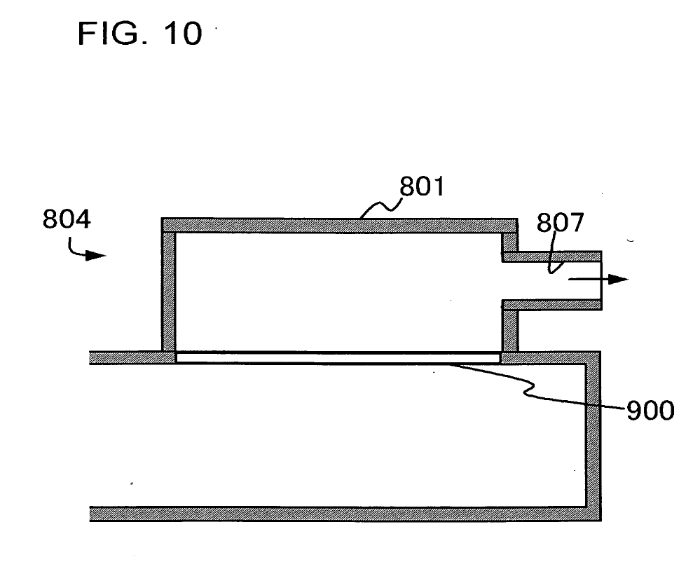

FIG. 9 is a plan view typically showing the structure of a fuel cell system in this embodiment. FIG. 10 is a cross-sectional view along the line A-A in the fuel cell system.

The fuel cell system 850 includes plural fuel cell unit cells 101, a fuel container 811 in which these plural fuel cell unit cells 101 are arranged and a fuel tank 851 that supplies fuel to the fuel container 811 and recovers the fuel circulated in the fuel container 811. The fuel container 811 and the fuel tank 851 are communicated with each other through a fuel passage 854 and a fuel passage 855. A gas discharge unit 804 is disposed above the fuel passage 855.

In this embodiment, fuel is supplied to the fuel container 811 through the fuel passage 854. The fuel flows along plural divided plates 853 disposed in the fuel container 811 and is supplied sequentially to the plural fuel cell unit cells 101. The fuel circulated around the plural fuel cell unit cells 101 is recovered to the fuel tank 851 through the fuel passage 855.

The fuel tank 851 may be made to be a cartridge structured so as to be detachable from the fuel cell system 850 body including the fuel container 811.

In the fuel cell system 850 in this embodiment, a gas discharge unit 804 is disposed at an opening part 856 of the fuel passage 855 through a filter 900. The gas discharge unit 804 has the structure shown in FIG. 10. Specifically, it has the structure in which the space inside of the gas discharge unit 804 is partitioned by the filter 900 and the gas in the fuel passage 855 is transmitted through the filter 900 and then, the treated gas 806 is discharged out of the system through a discharge port 807. The gas discharge unit 804 is attached to the fuel passage 855 by a predetermined fixing device and is structured so as to be detachable from the fuel passage 855. Here, though the gas is designed to be discharged in the direction of the arrow in FIG. 10, the direction of the gas to be discharged may be arbitrarily designed by changing the shape of the discharge port.

This embodiment efficiently prevents the occurrence of the phenomena that carbon dioxide adheres to the fuel electrode 102, which is a cause of a reduction in cell efficiency and the generation of carbon dioxide increases pressure, which is a cause of breakage of the fuel container 811.

### Seventh Embodiment

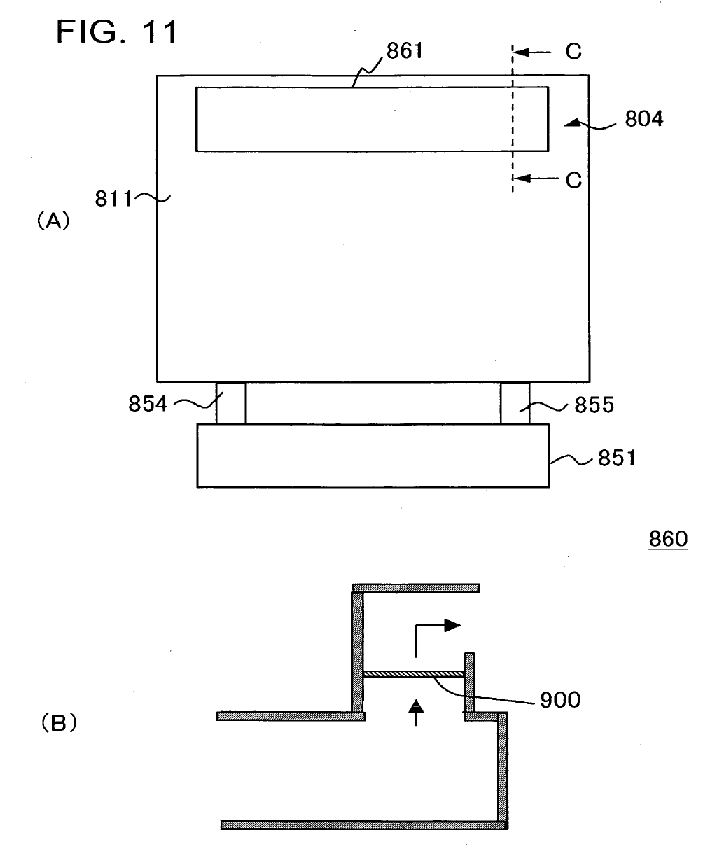

FIG. 11 (A) is a partially cross-sectional view typically showing a fuel cell system in this embodiment. FIG. 11 (B) is a cross-sectional view along the line C-C of this fuel cell system.

A fuel cell system 860 includes a fuel container 811 in which plural fuel cell unit cells are arranged and a fuel tank 851 that supplies fuel to the fuel container 811 and recovers the fuel circulated in the fuel container 811. The fuel container 811 and the fuel tank 851 are communicated with each other through a fuel passage 854 and a fuel passage 855. A gas discharge unit 861 is disposed above the fuel passage 855.

The cross-sectional structure of the gas discharge unit 861 is shown in FIG. 11B. The gas discharge unit has a structure in which gas in the fuel container 811 is discharged externally through a vapor-liquid separating filter 900. Here, though the gas is designed to be discharged in the direction of the arrow, the direction of the gas to be discharged may be arbitrarily designed by changing the shape of the discharge port.

According to this embodiment, an increase in the space occupied by providing the gas discharge unit can be suppressed to a minimum.

### EXAMPLES

### Example 1

First, the ability of the filter to remove byproducts and methanol was verified. The filter was designed to use porous PTFE (hole diameter: 1 μm) 50 μm in thickness as the vapor-liquid separation membrane and non-porous PTFE which is 1 μm in thickness as the carbon dioxide permselective membrane. These thicknesses respectively indicate an average. The filter was produced by applying a PTFE-containing solution to the surface of the porous membrane PTFE by spin coating and by drying the coating membrane at ambient temperature.

The gas permeability of the non-porous PTFE used in this embodiment is as follows.
CO₂: 280,000 cB
O₂: 99,000 cB
N₂: 49,000 cB
Methane: 34,000 cB

Here, cB means a unit “centi-BARRIER” and its value indicates the flow rate of gas transmitted through the membrane when measured in the same condition. This non-porous PTFE is found to be a membrane that selectively transmits carbon dioxide.

As the catalyst in the fuel cell section, platinum/ruthenium was used in the fuel electrode and platinum was used in the oxidant electrode. As the structural material of the solid electrolyte membrane, Nafion (registered trademark) was used.

### Example 2

A filter was produced in the same manner as in Example 1 except that poly 1H, 1H-perfluorooctyl methacrylate was used as the structural material of the carbon dioxide permselective membrane. The carbon dioxide permselective membrane was formed by applying a perfluorohexane solution of poly 1H, 1H-perfluorooctyl methacrylate to the surface of porous membrane PTFE by spin coating.

### Comparative Example 1

As to the filter, it was structured only of the vapor-liquid separation membrane constituted only of 50-μm-thick porous PTFE (hole diameter: 1 μm) in place of the filter having a double layer structure.

### Comparative Example 2

As a comparative example provided with no filter, a catalyst membrane obtained by impregnating a porous support with platinum microparticles was prepared.

The separating performance of the filter was verified in an environment where methanol, formic acid and methyl formate were present in a much larger amount than in an environment where usual fuel cells were used. Specifically, a mixed solution of methanol, formic acid and methyl formate was placed in a container like the fuel container 811 as shown in FIG. 1 and heated minutely to thereby vaporize the solution. Then, the components transmitted through the filter were sampled to verify the separating performance of the filter. The concentration of methanol and the concentration of formic acid and methyl formate in the discharged gas which had been sampled were measured by gas chromatography. The results are shown in Table 1.

TABLE 1

| | CONCEN- | CONCEN- | CONCEN- |
|---|---|---|---|
| | TRATION OF | TRATION | TRATION |
| | METHANOL | OF FORMIC | OF METHYL |
| | (μg/L) | ACID (μg/L) | FORMATE (μg/L) |
| EXAMPLE 1 | 4500 | 160 | 660 |
| EXAMPLE 2 | 4200 | 150 | 630 |
| COMPARATIVE | 16900 | 690 | 7390 |
| EXAMPLE 1 | | | |
| COMPARATIVE | 8600 | 310 | 4460 |
| EXAMPLE 2 | | | |

From these results, it is found that methanol, formic acid and methyl formate are separated by using the filter according to the present invention. Also, the solution was further heated to thereby promote the vaporization of the solution and then, the components transmitted through the filter were sampled to verify the separating performance of the filter. The concentration of methanol and the concentration of formic acid and methyl formate in the discharged gas which had been sampled were measured by gas chromatography. The results are shown in Table 2.

TABLE 2

| | CONCEN- | CONCEN- | CONCEN- |
|---|---|---|---|
| | TRATION OF | TRATION | TRATION OF |
| | METHANOL | OF FORMIC | METHYL |
| | (μg/L) | ACID (μg/L) | FORMATE (μg/L) |
| EXAMPLE 1 | 6800 | 240 | 980 |
| EXAMPLE 2 | 6400 | 230 | 930 |
| COMPARATIVE | 26400 | 1040 | 10860 |
| EXAMPLE 1 | | | |
| COMPARATIVE | 14200 | 560 | 6050 |
| EXAMPLE 2 | | | |

It was found from these results that methanol, formic acid and methyl formate were efficiently separated by using the filter of the present invention even when these components were present in a large amount.

Next, a mixed solution of methanol, formic acid and methyl formate was placed in a container like the fuel container 811 as shown in FIG. 3 and heated in the condition as shown in Table 2 to thereby vaporize the solution. Then, the components transmitted through each filter used in Example 1, Example 2 and Comparative Example 1 and through the catalyst membrane were sampled to verify the separating performance of the filter as Examples 3 and 4 and Comparative Example 3. As the catalyst membrane, one obtained by impregnating a porous support with platinum microparticles was used. Also, the concentration of methanol and the concentration of formic acid and methyl formate in the discharged gas sampled in Comparative Example 1 were measured by gas chromatography. The results are shown in Table 3.

TABLE 3

| | CONCEN- | CONCEN- | CONCEN- |
|---|---|---|---|
| | TRATION OF | TRATION | TRATION OF |
| | METHANOL | OF FORMIC | METHYL |
| | (μg/L) | ACID (μg/L) | FORMATE (μg/L) |
| EXAMPLE 3 | 3500 | 120 | 490 |
| EXAMPLE 4 | 3300 | 110 | 450 |
| COMPARATIVE | 10300 | 490 | 5490 |
| EXAMPLE 3 | | | |

It was found from these results that even when a large amount of vapors of methanol, methyl formate and the like was generated, the present invention restrains these vapors from being emitted in the air more efficiently.

Next, fuel cell systems as shown in FIG. 1 were constituted using each filter of Examples 1 and 2 and Comparative Example 1 and were operated in the following operating condition. Also, a fuel cell system as shown in FIG. 3 was constituted using a structure of a combination of each filter of Examples 3 and 4 and Comparative Example 3 and a catalyst membrane and likewise operated in the following condition.
Fuel: Mixed solution containing methanol and water
Operating temperature: 40° C.
Power (current density): 50 mA/cm²

The fuel cell was operated continuously for 5 hours in the above condition. In Examples 1 to 4, no reduction in output was found after the operation was carried out for 5 hours whereas in Comparative Example 1, the consumption of methanol in the fuel was large, bringing about decreased fuel concentration and the power of the cell was therefore largely decreased. Also, the discharged gas transmitted through the filter was sampled to measure the concentration of methanol and the concentration of formic acid and methyl formate by gas chromatography. The results are shown in Table 4.

TABLE 4

| | CONCEN- | CONCEN- | CONCEN- |
|---|---|---|---|
| | TRATION OF | TRATION | TRATION OF |
| | METHANOL | OF FORMIC | METHYL |
| | (μg/L) | ACID (μg/L) | FORMATE (μg/L) |
| EXAMPLE 1 | 130 | 5 | 180 |
| EXAMPLE 2 | 210 | 6 | 200 |
| EXAMPLE 3 | 100 | 2 | 87 |
| EXAMPLE 4 | 110 | 3 | 96 |
| COMPARATIVE | 920 | 33 | 950 |
| EXAMPLE 1 | | | |
| COMPARATIVE | 380 | 14 | 440 |
| EXAMPLE 3 | | | |

It was clarified from these results that the present invention enabled a remarkable reduction in the concentrations of byproduct gases and methanol gas in the discharged gas which could be generated in the operation of a fuel cell system.

It was clarified from the above results that the structure as described in the examples made it possible to suppress the discharge of other components while efficiently discharging carbon dioxide out of a fuel cell system and it was therefore possible to improve the efficiency of a fuel cell.

1. A fuel cell system having:
a fuel cell provided with a fuel electrode, an oxidant electrode and an electrolyte membrane sandwiched between them, and
a fuel supply system supplying fuel to said fuel electrode, comprising;
a gas discharge unit provided with a filter at a part of a member which excludes a reaction part of said fuel electrode and is in contact with the fuel,
wherein said filter is constituted of a substrate and a carbon dioxide permselective membrane provided on the substrate.

2. The fuel cell system of claim 1,
wherein the fuel to be supplied is liquid fuel and said substrate is a vapor-liquid separation membrane.

3. The fuel cell system of claim 1,
wherein said carbon dioxide permselective membrane has a thickness of 5 μm or less.

4. The fuel cell system of claim 1,
wherein said filter has a structure further provided with a porous membrane on said carbon dioxide permselective membrane.

5. The fuel cell system of claim 1,
wherein said gas discharge unit is provided with a chamber communicated with said fuel supply system through said filter; and
a catalyst is disposed in said chamber or on the wall surface of the chamber.

6. The fuel cell system of claim 1,
wherein said gas discharge unit is provided with;
a first chamber that has an air port provided with a filter and is communicated with said fuel supply system through said filter; and
a second chamber that is communicated with said first chamber and provided with a catalyst in the chamber or on the wall surface of the chamber.
